(19) United States
(12) Patent Application Publication
(10) Pub. No.: US 2024/0330933 A1
(43) Pub. Date: Oct. 3, 2024

(54) TRANSACTION-LEVEL RISK ASSESSMENT BASED ON HIGHER-LEVEL ACCOUNT REPUTATION SCORE

(71) Applicant: Microsoft Technology Licensing, LLC, Redmond, WA (US)

(72) Inventors: Amir Reza BIAGI, Mercer Island, WA (US); Vishnu NANDAKUMAR, Redmond, WA (US); Qiuyu Long, Seattle, WA (US); Zimin Zhong, Kenmore, WA (US); Shao Ou Chin, Bellevue, WA (US); Jun Shen, Bellevue, WA (US); Di Lai, Bellevue, WA (US)

(21) Appl. No.: 18/190,637

(22) Filed: Mar. 27, 2023

(51) Int. Cl. G06Q 20/40

(52) U.S. Cl. CPC G06Q 20/4016

(57) ABSTRACT

Described are examples for providing a metric for assessing risk of a request for a transaction offered by a service. A set of factors related to the request for the transaction can be received for a transaction-level account. A risk metric associated with the request can be computed based on a portion of the set of factors and based on a reputation score (RS) for a higher-level account associated with the transaction-level account. An indication of at least one of the RS or the risk metric computed based on the RS can be provided to the service for assessing risk associated with the request.

### BACKGROUND

Cloud-based computing platforms have been provided to facilitate allocating distributed compute resources or services to a multitude of users for storing data, executing processes, etc. Users can subscribe to the cloud-based computing platform or to one or more services provided by resources of the cloud-based computing platform. Generally, a user of the cloud-based computing platform or of the service can be associated with a subscriber account on the cloud-based computing platform or the service. The subscriber account may also be associated with a higher-level account on the cloud-based computing platform, such as a company, school, or other enterprise, a division of a company, etc. for the user. When a user requests subscription or other transactions at an account level below the higher-level account, various factors can be indicated by the user and assessed at the time of the request for determining whether to accept or reject the request. The logic for detecting potential fraud or otherwise determining whether to accept or reject the request can be part of the service provided by the cloud-based computing platform and may vary across services for the specific purpose of detecting potential fraud for the given request. Other architectures also allow for transactions at one account level to be requested or performed, where the account corresponds to a higher-level account, such as.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a device for providing a metric for assessing risk of a request for a transaction offered by a service is provided that includes a memory storing instructions, and a processor coupled to the memory. The processor is configured to execute the instructions to receive, for a transaction-level account, a set of factors related to the request for the transaction, compute, based on a portion of the set of factors, a reputation score (RS) for a higher-level account associated with the transaction-level account, and provide, to the service based on receiving the set of factors, an indication of at least one of the RS or a risk metric, computed based on the RS and associated with the request, for assessing risk associated with the request.

In another example, a computer-implemented method for providing a metric for assessing risk of a request for a transaction offered by a service is provided that includes receiving, for a transaction-level account, a set of factors related to the request for the transaction, computing, based on at least a portion of the set of factors and based on a RS for a higher-level account associated with the transaction-level account, a risk metric associated with the request, providing, to the service, an indication of at least one of the RS or the risk metric computed based on the RS for assessing risk associated with the request, and approving or rejecting, via the service, the request based on comparing the RS or the risk metric to a threshold.

In another example, a non-transitory computer-readable device is provided having stored instructions thereon that, when executed by a computing device, cause the computing device to perform operations for providing a metric for assessing risk of a request for a transaction offered by a service. The operations includes receiving, for a transaction-level account, a set of factors related to the request for the transaction, computing, based on at least a portion of the set of factors and based on a RS for a higher-level account associated with the transaction-level account, a risk metric associated with the request, and providing, to the service, an indication of at least one of the RS or the risk metric computed based on the RS for assessing risk associated with the request.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a device for performing functions related to providing transaction-level risk assessment based on higher-level account reputation score (RS), in accordance with aspects described herein.

FIG. 2 is a flow diagram of an example of a method for assessing risk associated with a transaction-level account based on a RS for a higher-level account, in accordance with aspects described herein.

FIG. 3 is a flow diagram of an example of a method for computing, maintaining, and/or providing a RS for a higher-level account, in accordance with aspects described herein.

FIG. 4 illustrates a conceptual flow of processes and data to facilitate RS computation and storage, in accordance with aspects described herein.

FIG. 5 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to assessing a risk of a transaction-level account request based on a reputation score (RS) of a higher-level account associated with the transaction-level account. In an example, one or more factors of the transaction request can also be used in assessing the risk of the transaction request. Moreover, in an example, the assessed risk can be quantified and used in modeling the RS of the higher-level account for subsequent risk assessments of other transaction-level accounts associated with the higher-level account. In this regard, the risk can be aggregated in multiple dimensions to provide, for an entity related to transaction-level accounts, a holistic view of the risk for a given subscriber-level account transaction request.

For example, the higher-level account can be associated with an real-world entity, such as an enterprise or an individual, and the higher-level account can have multiple associated transaction-level accounts. For example, where the higher-level account is an enterprise, the transaction-level accounts can be associated with users of the enterprise. For example, where the higher-level account is an individual, the transaction-level accounts can be associated with various transactions of the individual. In an example, the transaction-level accounts can be subscription-level accounts corresponding to a subscription for goods or services or resources (e.g., of a cloud-based computing platform). In another example, the transaction-level account transaction requests can correspond to a service provided by, or executing on, a larger system, such as a cloud-based computing platform, and the higher-level account can correspond to the cloud-based computing platform. In another example, the transaction-level account can be associated with a one-time purchase of goods or services or resources. Each account can include information such as account holder identification information (e.g., name), billing details, address, etc. In any case, there can be a one-to-many relationship between a higher-level account and transaction-level accounts. In this example, various services can each independently obtain the RS associated with the higher-level account for assessing risk of the transaction-level account transaction requests for various transaction-level accounts, and/or may use more specific risk assessing functionality for the given service.

The RS can be generated from a classification model, which can include calculating a probability score. Modeling the higher-level account RS in this regard can provide a more accurate view of risk associated with the transaction-level accounts. This can be a classification problem where the task of the model is to differentiate effectively between fraud and non-fraud. For example, some activity having associated risk for a higher-level account may be permitted without significantly impacting requests from other transactions or transaction-level accounts associated with the higher-level account, where the higher-level account has a RS indicating little to no risk. Similarly, for example, transaction requests for transaction-level accounts associated with a higher-level account having a RS indicating higher risk may not be allowed or may be allowed only where no additional risk is observed in the transaction request. Using this holistic view allows for improved risk assessment over other systems that only consider transaction-level factors of the transaction requests at the transaction level. The RS can provide a measure of “trust” for the higher-level account. The score and related information can provide guidance for capacity allocation decisions, which can reduce customer friction across a provider of the cloud-based computing platform while providing other friction to discourage fraudsters from taking advantage of the platform. Aspects described herein can facilitate detecting cases of fraud while minimizing false positives, where false positives may have a negative impact on the customer experience. In addition, associating RS with higher-level customer accounts can be further strengthened by leveraging additional signals coming into the service being provided and/or the cloud-based computing platform. This approach can also be supported by success metrics that are designed to assist in optimizing for customer experience goals.

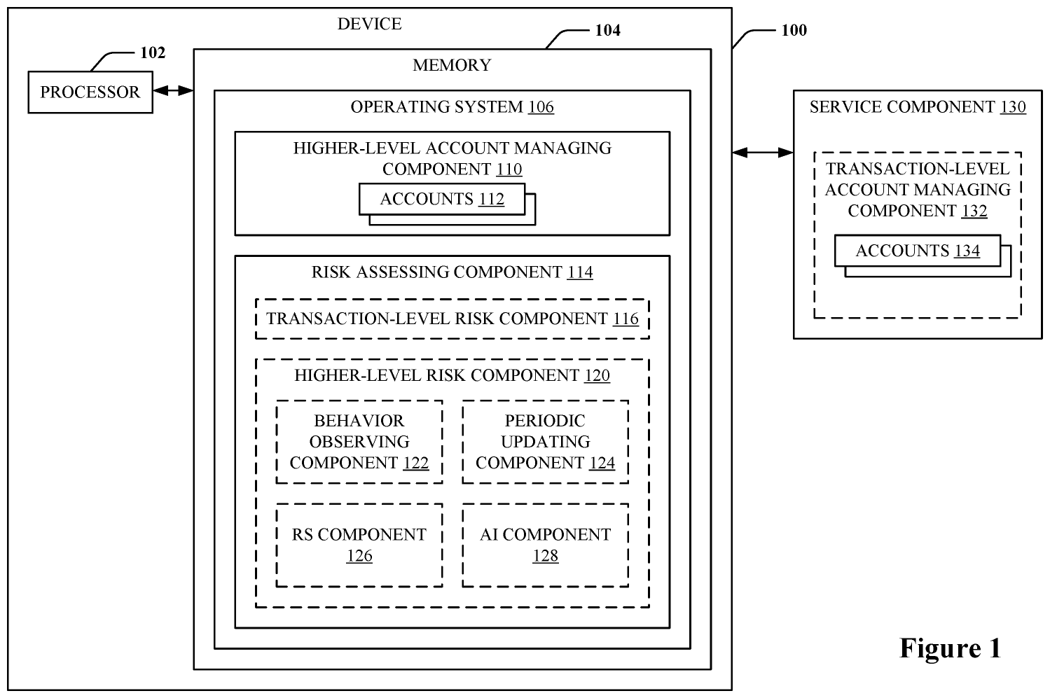

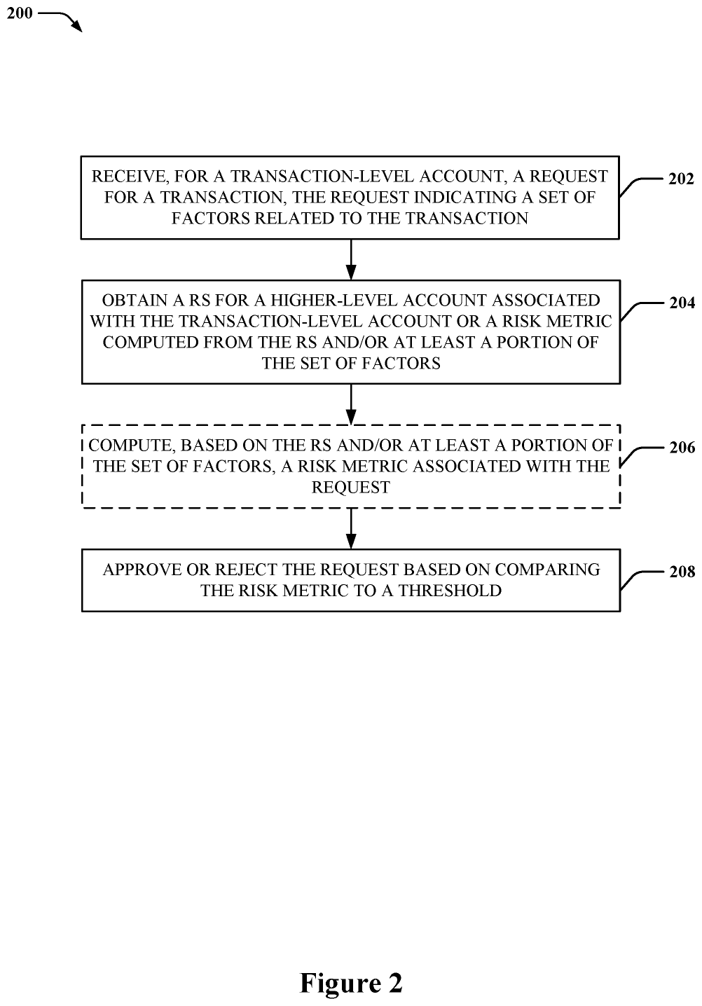

Turning now to FIGS. 1-5, examples are depicted with reference to one or more components and one or more methods that may perform the actions or operations described herein, where components and/or actions/operations in dashed line may be optional. Although the operations described below in FIG. 2 are presented in a particular order and/or as being performed by an example component, the ordering of the actions and the components performing the actions may be varied, in some examples, depending on the implementation. Moreover, in some examples, one or more of the actions, functions, and/or described components may be performed by a specially programmed processor, a processor executing specially-programmed software or computer-readable media, or by any other combination of a hardware component and/or a software component capable of performing the described actions or functions.

FIG. 1 is a schematic diagram of an example of a device 100 (e.g., a computing device) for performing functions related to providing transaction-level risk assessment based on higher-level account reputation score (RS). In an example, device 100 can include a processor 102 and/or memory 104 configured to execute or store instructions or other parameters related to providing an operating system 106, which can execute one or more applications or processes. For example, processor 102 and memory 104 may be separate components communicatively coupled by a bus (e.g., on a motherboard or other portion of a computing device, on an integrated circuit, such as a system on a chip (SoC), etc.), components integrated within one another (e.g., processor 102 can include the memory 104 as an on-board component), and/or the like. Memory 104 may store instructions, parameters, data structures, etc. for use/execution by processor 102 to perform functions described herein.

In one example, the operating system 106 can execute one or more applications or processes, such as, but not limited to, a higher-level account managing component 110 for managing higher-level accounts 112 related to one or more services, and/or a risk assessing component 114 for assessing risk associated with a transaction-level account or corresponding transaction request, a higher-level account associated with transaction-level account, etc. In an example, risk assessing component 114 can optionally include a transaction-level risk component 116 for analyzing risk at a transaction level for a transaction request, and/or a higher-level risk component 120 for generating and/or providing a reputation score for a higher-level account, which can be used by the transaction-level risk component 116 in analyzing risk for the transaction-level transaction request. In an example, higher-level risk component 120 can optionally include a behavior observing component 122 for observing behaviors of, or receiving observations of behaviors of, a transaction-level account in using the service provided by service component 130, a periodic updating component 124 for periodically updating a RS for a higher-level account, a RS component 126 for storing or managing a RS for the higher-level account, and/or an artificial intelligence (AI) component 128 for using AI or machine-learning (ML) models or mechanisms for computing an RS for the higher-level account. In an example, though shown in a single device 100, one or more of the various components 110, 114, 116, 120, 122, 124, 126, and/or 128, may be provided by, or otherwise stored on, a different device, with which device 100 can communicate (e.g., over a network). In an example, one or more of the components 110, 114, 116, 120, 122, 124, 126, and/or 128, may be provided in a cloud-based computing platform and may be implemented by various distributed devices, distributed processors, distributed memories, etc.

Device 100 can also communicate with a service component 130, which can be part of the device 100 or can be otherwise be accessed by the device 100 (e.g., via one or more networks). Though not shown for ease of explanation, service component 130 can execute on a different device, having a processor, memory, operating system, etc., and/or via cloud-based computing platform resources, etc. Service component 130 can include a transaction-level account managing component 132 for managing multiple transaction-level accounts 134 for providing a service to users or associated devices (not shown for case of explanation) based on an authenticated transaction-level account. In an example, service component 130 can communicate with the device 100 and/or risk assessing component 114, e.g., over one or more networks, to receive a RS associated with a transaction-level account, or a higher-level account associated with the transaction-level account.

In one example, service component 130 can receive a request for a new transaction-level account 134 or to modify a current transaction-level account 134. In this example, transaction-level account managing component 132 can assess a risk associated with the new account request or modification request, which can be based on one or more factors indicated in the request. In addition, as part of assessing the risk, transaction-level account managing component 132 can obtain a RS of a higher-level account associated with the transaction-level account in determining whether to accept or reject the request. For example, transaction-level account managing component 132 can request the RS from higher-level account managing component 110, and higher-level account managing component 110 can determine which higher-level account 112 is associated with the transaction-level account 134. For example, the transaction-level account 134 may include identifying information for identifying the higher-level account associated with the transaction-level account 134. For example, the higher-level account may include a company, school, or other enterprise or entity associated with the transaction-level account request, which may be based on a domain associated with a user name for the transaction-level account, other subscription information associated with the transaction-level account (e.g., an indication of the higher-level account or the entity associated with the higher-level account, etc.

In one example, transaction-level account managing component 132 can provide the one or more factors associated with the transaction request to the risk assessing component 114 to assess the risk of the transaction request. In this example, risk assessing component 114 can compute a risk metric associated with the transaction request based on computing the transaction-level risk associated with the transaction-level account and/or a higher-level risk associated with the higher-level account. In one example, transaction-level risk component 116 can compute the transaction-level risk associated with the transaction-level account based on obtaining a RS for the higher-level account and based on the one or more factors. For example, the one or more factors can correspond to the transaction request, and may include payment-related features for the service, such as geographic information, domain, payment account, internet protocol (IP)-related features, etc., raw features, such as age, gender, country, etc., transaction-level account usage features, such as time of usage, resources used, payment history or propensity to pay, usage of a faulty or possibly fraudulent credit card or payment account, etc., and/or the like. In an example, e.g., for a first risk assessment corresponding to the higher-level account, transaction-level risk component 116 can compute a risk metric based on one or more of these factors and may provide the risk metric to higher-level risk component 120. RS component 126 can store the risk metric and/or use the risk metric to update a RS for the higher-level account. In another example, transaction-level risk component 116 can provide the one or more factors, or a subset of the factors, to the higher-level risk component 120 to allow the higher-level risk component 120 to compute or update the RS for the higher-level account based on the factors or subset of factors.

In an example, RS component 126 can provide the RS for the higher-level account to the transaction-level risk component 116 and/or back to service component 130 for use in assessing a risk of the transaction request from the transaction-level account, which may be based on the RS for the higher-level account and/or the one or more factors of the transaction request. In this regard, for example, the RS for the higher-level account can be considered in assessing risk for the transaction request. In an example, based on the assessed risk, e.g., based on comparing the assessed risk to a threshold, the transaction request for the transaction-level account can be approved or rejected.

In addition, in an example, behavior observing component 122 can observe, or receive observation parameters of (e.g., from the service component 130), behaviors associated with the transaction-level account when using the service provided by service component 130. In an example, based on detecting certain behaviors, behavior observing component 122 can indicate the behaviors to higher-level risk component 120, and higher-level risk component 120 can update the RS for the higher-level account based on the behaviors. For example, behavior observing component 122 can trigger indication of the behaviors to higher-level risk component 120 when detected. The behaviors can relate to certain uses of the service, which may be determined as possibly having an associated risk.

In another example, periodic updating component 124 can periodically update the RS for the higher-level account, such as every 24 hours, or according to a different time period. For example, periodic updating component 124 can periodically provide parameters regarding uses of the service by the transaction-level account during the time period to higher-level risk component 120, and higher-level risk component 120 can update the RS for the higher-level account based on the parameters.

In another example, AI component 128 can build a classification model, using artificial intelligence (AI) or machine-learning (ML), for classifying RS, which can facilitate determining or computing RS for a specific higher-level account based on various factors of transaction requests from associated transaction-level accounts. For example, the focus of the classification model can be on the features that directly align with a given business need over multiple touchpoints. After establishing a set of features and related training data for the classification model, such as one or more of the features described above, fraud labels can be validated. Fraud labels that are created due to policy rejections may be removed from the training data, as these policies may change over time. Also, as actual fraud can be a relatively infrequent event, associated metrics can be selected to ensure the model is desirably optimized.

For example, the AI component 128 can calibrate probabilities generated from the classification model. One goal of the classification model can be to predict a real-time account level score for every account, subscription-agnostic, which may be used across the customer lifecycle to determine an account's likelihood of being trustworthy. In this way, it can be important to calibrate scores so that they accurately represent trustworthiness. The final classification model can produce both a raw score and a calibrated score, where the calibrated score can be made available to the services provided by service component 130. The raw score can include a probability score produced by the classification model that predicts the likelihood of the given account being fraudulent, where the score may range from 0 to 1—the higher the score, the higher the risk or likelihood of fraud. The calibrated score, which can be the RS, can be produced by the classification model for providing to the services provided by service component 130 to aid decision making, where the score can range from 0 to 1000 (or another number). In one example, the higher the score, the lower the risk or likelihood of fraud.

In this example, in using the classification model to compute a RS for a higher-level account, RS component 126 can provide inputs to the trained classification model via AI component 128, where the inputs can include factors of various transaction-level transaction requests or other detected behaviors for transaction-level accounts, as described above. AI component 128 can provide a corresponding RS output by the classification model based on the factors. RS component 126 can store the RS for the higher-level account for providing for assessing risk of a transaction request by a transaction-level account on a service of the service component 130, as described.

FIG. 2 is a flowchart of an example of a method 200 for assessing risk associated with a transaction-level account based on a RS for a higher-level account. For example, method 200 can be performed by a device 100 or other device, and/or one or more components thereof, to facilitate obtaining the RS for the higher-level account and/or for using the RS as part of approving or rejecting a transaction-level transaction request.

In method 200, at action 202, a request for a transaction can be received for a transaction-level account, the request indicating a set of factors related to the transaction. In an example, transaction-level account managing component 132, e.g., in conjunction with a processor, memory, operating system, etc. of a device providing the transaction-level account managing component 132, can receive, for the transaction-level account, the request for the transaction, the request indicating the set of factors related to the transaction. For example, service component 130 can provide a service that can execute on, and/or can facilitate utilizing resources of, a cloud-based computing platform. The service can offer varying levels of subscription to the service and/or cloud-based computing platform, which may have associated payment costs. In one example, the service can provide a subscription mechanism to setup and pay for a new transaction-level account for the service, which can generate the transaction request. In another example, the service can provide an upgrade or other event that causes a change in subscription level or other services provided to the transaction-level account, which can also generate the transaction request. The set of factors indicated in or for to the transaction request can include factors described above, such as payment-related features, raw features, transaction-level account usage features, etc. As described, in one example, at least a portion of the set of factors can allow for a single closed-world assessment of a risk of the transaction request being fraudulent. In aspects described herein, however, the RS of the higher-level account can also be considered to provide a more holistic assessment of risk.

In method 200, at action 204, a RS for a higher-level account associated with the transaction-level account, or a risk metric computed from the RS and/or at least a portion of the set of factors, can be obtained. In an example, transaction-level account managing component 132, e.g., in conjunction with a processor, memory, operating system, etc. of a device providing the transaction-level account managing component 132, can obtain the RS for a higher-level account associated with the transaction-level account, or the risk metric computed from the RS and/or at least a portion of the set of factors. For example, transaction-level account managing component 132 can obtain the RS for the higher-level account from a risk assessing component 114 that manages RSs for various higher-level accounts based on using a classification model to output a RS for the various higher-level accounts from inputs related to associated transaction-level accounts, as described herein. In another example, the risk assessing component 114 may compute a risk metric for the transaction based on at least a portion of the set of factors provided by the transaction-level account managing component 132.

In method 200, optionally at action 206, a risk metric associated with the request can be computed based on the RS and/or at least a portion of the set of factors. In an example, transaction-level account managing component 132, e.g., in conjunction with a processor, memory, operating system, etc. of a device providing the transaction-level account managing component 132, can compute, based on the RS and/or at least the portion of the set of factors, the risk metric associated with the request. For example, transaction-level account managing component 132 can compute the risk metric—e.g., if not obtained from the risk assessing component 114—as a function of the obtained RS and/or as a function of at least one or more of the set of factors. For example, as described, the RS can be used to supplement a computation used for assessing the risk associated with the transaction request, whether performed by the transaction-level account managing component 132 or the risk assessing component 114. In another example, the risk metric can be the RS.

In method 200, at action 208, the request can be approved or rejected based on comparing the risk metric to a threshold. In an example, transaction-level account managing component 132, e.g., in conjunction with a processor, memory, operating system, etc. of a device providing the transaction-level account managing component 132, can approve or reject the request based on comparing the risk metric to the threshold. For example, transaction-level account managing component 132 may approve the transaction request for the service provided by service component 130 where the risk metric achieves a threshold. In one specific example, the RS can be a calibrated risk score, as described above, which may range from 0 to 1000, and transaction-level account managing component 132 can approve the transaction if the RS is above a certain threshold. In another example, the RS can be normalized and/or used in another computation of the risk metric. In yet another example, transaction-level account managing component 132 can compare the RS to the threshold as part of assessing risk, and/or may compute or compare a risk metric for the transaction after verifying that the RS achieves the threshold.

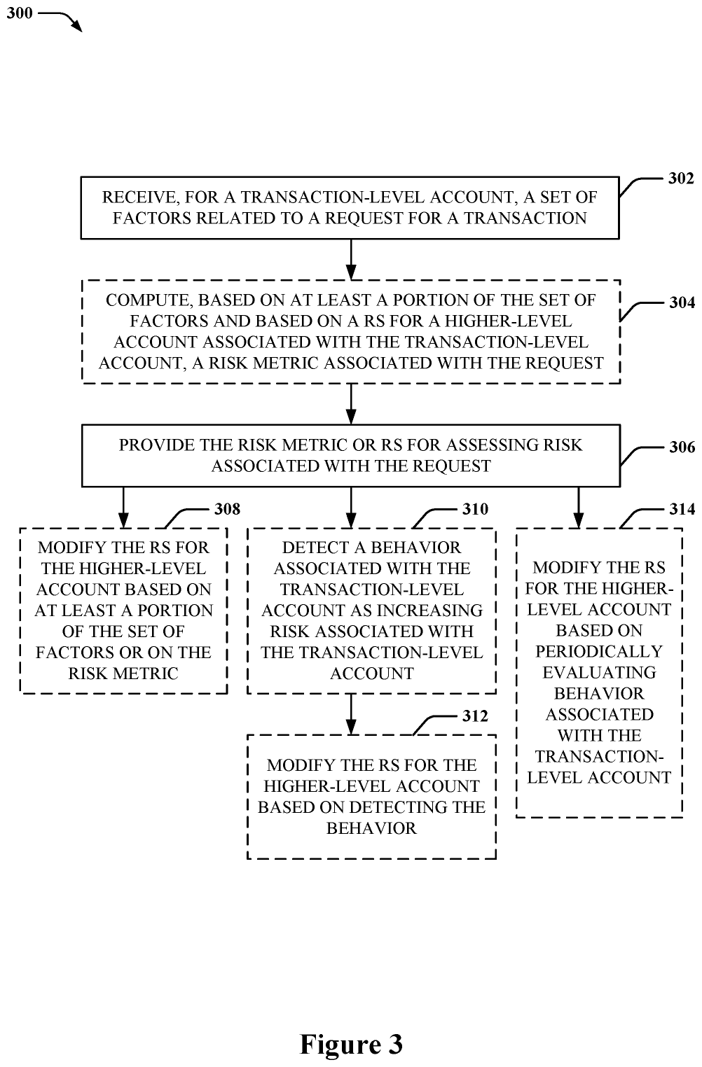

FIG. 3 is a flowchart of an example of a method 300 for computing, maintaining, and/or providing a RS for a higher-level account. For example, method 300 can be performed by a device 100 and/or one or more components thereof to facilitate generating the RS for the higher-level account.

In method 300, at action 302, a set of factors for a transaction-level account related to a request for a transaction can be received. In an example, risk assessing component 114, e.g., in conjunction with a processor 102, memory 104, operating system 106, etc., can receive, for the transaction-level account, the set of factors related to the request for the transaction. For example, risk assessing component 114 can receive the set of factors from a service component 130 for assessing a risk associated with a transaction request. In one example, risk assessing component 114 can receive, from the service component 130, the transaction request or the set of factors from the transaction request (or at least a portion of the set of factors) for computing a risk metric and/or updating a RS associated with a higher-level account.

In method 300, optionally at action 304, a risk metric associated with the request can be computed based on at least a portion of the set of factors and based on a RS for a higher-level account associated with the transaction-level account. In an example, risk assessing component 114, e.g., in conjunction with a processor 102, memory 104, operating system 106, etc., can compute, based on at least the portion of the set of factors and based on the RS for the higher-level account associated with the transaction-level account, the risk metric associated with the request. As described above with respect to transaction-level account managing component 132, risk assessing component 114 can compute the risk metric as a function of the RS for the higher-level account and/or as a function of at least one or more of the set of factors. For example, as described, the RS can be used to supplement a computation used for assessing the risk associated with the transaction request.

In method 300, at action 306, the risk metric or RS can be provided for assessing risk associated with the request. In an example, risk assessing component 114, e.g., in conjunction with a processor 102, memory 104, operating system 106, etc., can provide (e.g., to the service component 130 or other component requesting a risk assessment or RS for a higher-level account) the risk metric or RS for assessing risk associated with the request. For example, risk assessing component 114 can request, from higher-level account managing component 110 for an indication of the higher-level account associated with the transaction-level account. Risk assessing component 114 can then obtain the RS for the higher-level account via RS component 126, and can provide the RS to the service component 130 or can otherwise use the RS in computing, via transaction-level risk component 116, the risk metric associated with the transaction request for providing to the service component 130.

As described, for example, AI component 128 can maintain the RS for the higher-level account by providing one or more factors from transaction requests for associated transaction-level accounts to a classification model to obtain the RS. For example, the classification model can be trained on similar factors and fraud determinations for transaction requests that were based on the factors, and can output a raw score, which can represent a risk of fraud for the higher-level account. RS component 126 can store the raw score for the higher-level account for providing the raw score, or a calibrated score computed from the raw score, to one or more service components 130 or other components requesting the RS. RS component 126 can periodically update the RS for the higher-level account by providing inputs to the classification model via AI component 128, which may be based on receiving a transaction request, based on a time period (e.g., every 24 hours), based occurrence of a detected event or behavior, and/or the like. In any case, RS component 126 can provide a most up-to-date RS of the higher-level account to a requesting component to assess risk associated with a transaction of a transaction-level account.

In method 300, optionally at action 308, the RS for the higher-level account can be modified based on at least a portion of the set of factors or on the risk metric. In an example, RS component 126, e.g., in conjunction with a processor 102, memory 104, operating system 106, etc., can modify the RS for the higher-level account based on at least the portion of the set of factors or on the risk metric. For example, transaction-level risk component 116 can provide the set of factors, or other information associated with the transaction request, to the RS component 126, and the RS component 126 can provide at least a portion of the set of factors, or a computed risk metric, to the classification model via AI component 128 for obtaining an updated RS for the higher-level account. RS component 126 can store the updated RS for the higher-level account obtained from the AI component 128.

In method 300, optionally at action 310, a behavior associated with the transaction-level account can be detected as increasing risk associated with the transaction-level account. In an example, behavior observing component 122, e.g., in conjunction with a processor 102, memory 104, operating system 106, etc., can detect the behavior associated with the transaction-level account as increasing risk associated with the transaction-level account. For example, behavior observing component 122 can detect the behavior based on requests from the transaction-level account that impact or otherwise utilize the higher-level account. In another example, behavior observing component 122 can detect the behavior based on information received from the service component 130 regarding transaction-level account activity with the provided service. Certain behaviors, or sequences of behaviors, may be defined as potentially indicating fraud, and behavior observing component 122 can be configured to detect the behaviors. For example, such behaviors may include transaction-level behaviors, such as attempting to pay for the service with a fraudulent credit card, service usage behaviors, such as attempting to access parts of the service reserved for other subscription levels, using system features in a manner suspected to be related to fraudulent activity, detecting a spike in utilized processing resources (e.g., centralized processing unit (CPU) or graphics processing unit (GPU) resources) on the cloud-based computing platform, etc.

In method 300, optionally at action 312, the RS for the higher-level account can be modified based on detecting the behavior. In an example, RS component 126, e.g., in conjunction with a processor 102, memory 104, operating system 106, etc., can modify the RS for the higher-level account based on detecting the behavior (e.g., at a time the behavior is detected). For example, RS component 126 can provide one or more factors of the behavior as input to the classification mode, via AI component 128, to output an updated RS, and can store the updated RS.

In method 300, optionally at action 314, the RS for the higher-level account can be modified based on periodically evaluating behavior associated with the transaction-level account. In an example, RS component 126, e.g., in conjunction with a processor 102, memory 104, operating system 106, etc., can modify the RS for the higher-level account based on periodically evaluating behavior associated with the transaction-level account. For example, RS component 126 can periodically (e.g., every 24 hours or according to another time period) provide factors from a list of recent transaction requests or other behaviors occurring over the time period and associated with transaction-level accounts as inputs to the classification model, via AI component 128, and can store the outputted updated RS for the higher-level account.

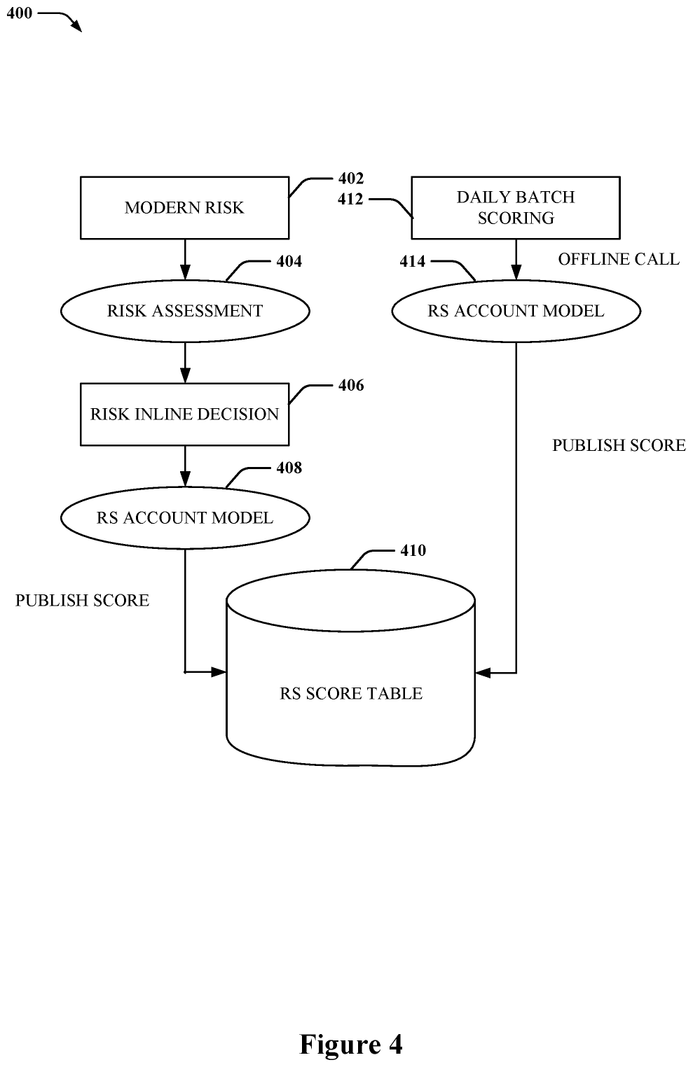

FIG. 4 illustrates a conceptual flow 400 of processes and data to facilitate RS computation and storage. A modern risk assessment process can be triggered at 402. such as by a transaction-level risk assessment for a service, which can be based on a transaction request associated with a transaction-level account, as described. The modern risk assessment can cause a real-time call for a risk assessment at 404. A risk inline decision process can be executed at 406 to make a risk assessment or decision, which can include computing a risk metric, as described above. For example, a rules engine can be provided for making the risk assessment, and if the factors of the transaction request do not comply with one or more rules, it can be deemed fraudulent, and the risk inline decision can indicate fraud and/or a predicted level or score of fraud for the transaction. One or more parameters of this risk inline decision can be provided to an RS account model at 408, and the RS account model can produce a score for publishing to a RS score table 410. The RS score table can include RSs for multiple higher-level accounts, as described in conjunction with RS component 126 above.

In addition, for example, a daily batch scoring process can be triggered at 412, which may be based on occurrence of a periodic event (e.g., expiration of a 24-hour timer). Similarly, in this example, parameters associated with activity of the transaction-level account within the time period can be provided to an RS account model via offline call at 414, and the RS account model can produce a score for publishing to a RS score table 410. In an example, whether the score is received from RS account model 408 or 414, the score can overwrite the RS stored for the higher-level account in the RS score table 410. For example, RS component 126 can perform this management and storage of the RS from the real-time call or the offline batch call. In one example, RS component 126 can update the RS with the RS from the offline batch call where a RS from a real-time call is not received within a threshold period of time from the offline batch call. For example, where RS component 126 receives the RS from the real-time call within the period of time before the offline batch call, RS component 126 may not store the RS form the offline batch call or may refrain from computing the periodic RS altogether.

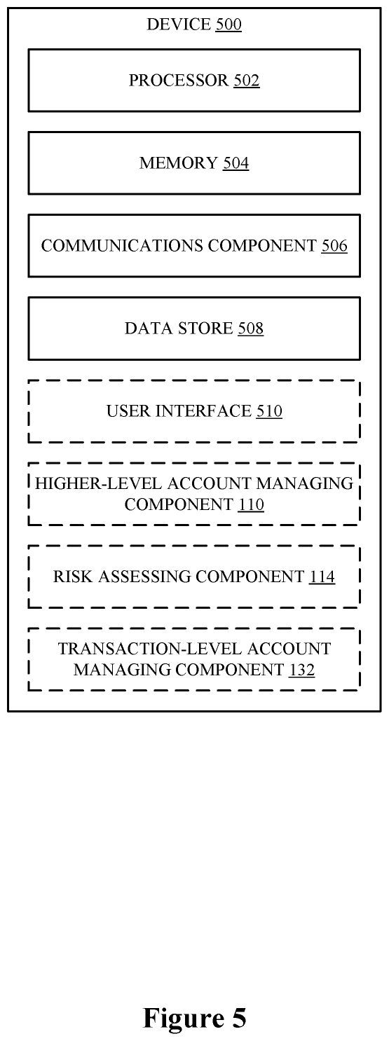

FIG. 5 illustrates an example of device 500 including additional optional component details as those shown in FIG. 1. In one aspect, device 500 may include processor 502, which may be similar to processor 102 for carrying out processing functions associated with one or more of components and functions described herein. Processor 502 can include a single or multiple set of processors or multi-core processors. Moreover, processor 502 can be implemented as an integrated processing system and/or a distributed processing system.

Device 500 may further include memory 504, which may be similar to memory 104 such as for storing local versions of operating systems (or components thereof) and/or applications being executed by processor 502, such as a higher-level account managing component 110, risk assessing component 114, transaction-level account managing component 132, one or more components thereof, etc. Memory 504 can include a type of memory usable by a computer, such as random-access memory (RAM), read only memory (ROM), tapes, magnetic discs, optical discs, volatile memory, non-volatile memory, and any combination thereof.

Further, device 500 may include a communications component 506 that provides for establishing and maintaining communications with one or more other devices, parties. entities, etc. utilizing hardware, software, and services as described herein. Communications component 506 may carry communications between components on device 500, as well as between device 500 and external devices, such as devices located across a communications network and/or devices serially or locally connected to device 500. For example, communications component 506 may include one or more buses, and may further include transmit chain components and receive chain components associated with a wireless or wired transmitter and receiver, respectively, operable for interfacing with external devices.

Additionally, device 500 may include a data store 508, which can be any suitable combination of hardware and/or software, which provides for mass storage of information, databases, and programs employed in connection with aspects described herein. For example, data store 508 may be or may include a data repository for operating systems (or components thereof), applications, related parameters, etc.) not currently being executed by processor 502. In addition, data store 508 may be a data repository for a higher-level account managing component 110, risk assessing component 114, transaction-level account managing component 132, one or more components thereof, and/or one or more other components of the device 500.

Device 500 may optionally include a user interface component 510 operable to receive inputs from a user of device 500 and further operable to generate outputs for presentation to the user. User interface component 510 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A device for providing a metric for assessing risk of a request for a transaction offered by a service, comprising:
a memory storing instructions; and
a processor coupled to the memory and configured to execute the instructions to:
receive, for a transaction-level account, a set of factors related to the request for the transaction;
compute, based on a portion of the set of factors, a reputation score (RS) for a higher-level account associated with the transaction-level account; and
provide, to the service based on receiving the set of factors, an indication of at least one of the RS or a risk metric, computed based on the RS and associated with the request, for assessing risk associated with the request.

2. The device of claim 1, wherein the processor is further configured to modify the RS for the higher-level account based on the risk metric.

3. The device of claim 2, wherein the processor is configured to modify the RS by providing the risk metric as input to a classification model to obtain an output corresponding to an updated RS for the higher-level account.

4. The device of claim 1, wherein the transaction corresponds to establishing the transaction-level account with the service.

5. The device of claim 1, wherein the transaction corresponds to obtaining, for the transaction-level account, additional resources associated with the service.

6. The device of claim 1, wherein the RS for the higher-level account is associated with risk metrics computed for multiple transaction-level accounts associated with the higher-level account.

7. The device of claim 1, wherein the processor is further configured to:
receive an indication of a behavior associated with the transaction-level account, wherein the behavior is classified as increasing risk associated with the transaction-level account; and
modify the RS for the higher-level account based on receiving the indication of the behavior.

8. The device of claim 7, wherein the processor is configured to modify the RS by providing one or more parameters associated with the behavior as input to a classification model to obtain an output of an updated RS for the higher-level account.

9. The device of claim 1, wherein the processor is further configured to modify the RS for the higher-level account based on periodically evaluating a set of factors of behaviors associated with the transaction-level account occurring over a period of time.

10. The device of claim 9, wherein the processor is configured to modify the RS by providing a portion of the set of factors as input to a classification model to obtain an output of an updated RS for the higher-level account.

11. The device of claim 1, wherein the processor is further configured to approve or reject the request based on the RS or the risk metric computed based on the RS.

12. A computer-implemented method for providing a metric for assessing risk of a request for a transaction offered by a service, comprising:
receiving, for a transaction-level account, a set of factors related to the request for the transaction;
computing, based on at least a portion of the set of factors and based on a reputation score (RS) for a higher-level account associated with the transaction-level account, a risk metric associated with the request;
providing, to the service, an indication of at least one of the RS or the risk metric computed based on the RS for assessing risk associated with the request; and
approving or rejecting, via the service, the request based on comparing the RS or the risk metric to a threshold.

13. The computer-implemented method of claim 12, further comprising modifying the RS for the higher-level account based on the risk metric.

14. The computer-implemented method of claim 12, wherein the transaction corresponds to establishing the transaction-level account with the service.

15. The computer-implemented method of claim 12, wherein the transaction corresponds to obtaining, for the transaction-level account, additional resources associated with the service.

16. The computer-implemented method of claim 12, wherein the RS for the higher-level account is associated with risk metrics computed for multiple transaction-level accounts associated with the higher-level account.

17. The computer-implemented method of claim 12, further comprising:
detecting a behavior associated with the transaction-level account as increasing risk associated with the transaction-level account; and
modifying the RS for the higher-level account based on detecting the behavior as increasing the risk associated with the transaction-level account.

18. The computer-implemented method of claim 12, further comprising modifying the RS for the higher-level account based on periodically evaluating behavior associated with the transaction-level account over a period of time.

19. A non-transitory computer-readable device storing instructions thereon that, when executed by a computing device, cause the computing device to perform operations for providing a metric for assessing risk of a request for a transaction offered by a service, comprising:
receiving, for a transaction-level account, a set of factors related to the request for the transaction;
computing, based on at least a portion of the set of factors and based on a reputation score (RS) for a higher-level account associated with the transaction-level account, a risk metric associated with the request; and
providing, to the service, an indication of at least one of the RS or the risk metric computed based on the RS for assessing risk associated with the request.

20. The non-transitory computer-readable device of claim 19, the operations further comprising modifying the RS for the higher-level account based on the risk metric.
